(19) United States
(12) Patent Application Publication
(10) Pub. No.: US 2014/0168854 A1
(43) Pub. Date: Jun. 19, 2014

(54) ELECTRODE STRUCTURE AND ENERGY STORAGE APPARATUS INCLUDING THE SAME

(71) Applicant: SAMSUNG ELECTRO-MECHANICS CO., LTD., Suwon-si (KR)

(72) Inventors: Bae Kyun KIM, Suwon-si (KR); Eun Sil KIM, Suwon-si (KR); Se Woong PAENG, Suwon-si (KR); Yeong Su CHO, Suwon-si (KR); Jae Hoon CHOI, Suwon-si (KR)

(73) Assignee: SAMSUNG ELECTRO-MECHANICS CO., LTD., Suwon-si (KR)

(21) Appl. No.: 14/101,190

(22) Filed: Dec. 9, 2013

(30) Foreign Application Priority Data
Dec. 14, 2012 (KR) 10-2012-0146764

(51) Int. Cl. H01G 11/28

(52) U.S. Cl. CPC H01G 11/28
USPC 361/502; 174/126.1

(57) ABSTRACT

Disclosed herein are an electrode structure and an energy storage apparatus including the same, the electrode structure including: a first current collector having a flat plate structure; second current collectors stacked on the first current collector and having a mesh structure; and active material layers formed on the first and second current collectors.

### CROSS REFERENCE(S) TO RELATED APPLICATIONS

This application claims the benefit under 35 U.S.C. Section 119 of Korean Patent Application Serial No. 10-2012-0146764, entitled “Electrode Structure and Energy Storage Apparatus including the Same” filed on Dec. 14, 2012, which is hereby incorporated by reference in its entirety into this application.

### BACKGROUND OF THE INVENTION

1. Technical Field

The present invention relates to an electrode structure and an energy storage apparatus including the same, and more particularly, to an electrode structure capable of having low electrode resistance, and an energy storage apparatus including the same capable of improving output and capacitance characteristics.

2. Description of the Related Art

Among next generation energy storage apparatus, a device called an ultra-capacitor or a super-capacitor has been prominent as a next generation energy storage apparatus due to rapid charging and discharging speed, high stability, and environment-friendly characteristics. As representative super-capacitors, a lithium ion capacitor (LIC), an electric double layer capacitor (EDLC), a pseudo-capacitor, a hybrid capacitor, and the like, are currently used.

In order to improve output characteristics of the super-capacitor, rated voltage should be increased, or equivalent series resistance (ESR) should be lowered. Generally, the rated voltage depends on an electrolyte solution, but in the case of using a non-aqueous electrolyte solution, the rated voltage is approximately 2.5 to 2.7 V. Therefore, in order to improve the output characteristics and cycle life characteristics of the super-capacitor, firstly, internal resistance should be reduced. To this end, it is important to reduce resistance of a positive electrode and a negative electrode.

In addition, the more amounts of active materials contacting the electrolyte solution, the further improved the capacitance characteristics of the energy storage apparatus. Therefore, the more the amount of the active material, the more advantages in improving the capacitance to increase electrode density so as to utilize all of the electrode space, but it is difficult to increase the density in a process at a predetermined density or more. Therefore, in order to improve the amount of an active material layer, a thickness of an electrode structure should be increased. However, when the thickness of the electrode structure is increased, since a thickness of the active material is increased and a length of a moving path of an electric charge is also increased, such that electrode resistance may be increased.

### RELATED ART DOCUMENT

### Patent Document

(Patent Document 1) Korean Patent Laid-Open Publication No. 10-2009-0099980

### SUMMARY OF THE INVENTION

An object of the present invention is to provide an electrode structure capable of improving output characteristics and cycle life characteristics, and an energy storage apparatus including the same.

Another object of the present invention is to provide an electrode structure capable of reducing resistance of a negative or positive electrode, and an energy storage apparatus including the same.

According to an exemplary embodiment of the present invention, there is provided an electrode structure including: a first current collector having a flat plate structure; second current collectors stacked on the first current collector and having a mesh structure; and active material layers formed on the first and second current collectors.

The second current collectors may be stacked in plural so as to face the first current collector, having the active material layer interposed therebetween.

The second current collector may have a plurality of through holes, and the through holes may be filled with the active material layer.

The electrode structure may be at least one of a negative electrode and a positive electrode that are disposed, having a separator therebetween, and the first current collector may be disposed at the outermost portion from the separator as compared with the second current collector.

The first current collector may have a first extension part extended in one direction, the second current collector may have a second extension part facing the first extension part, and the electrode structure may further include a connection part connecting the first and second extension parts to each other.

The first current collector may be a metal foil made of copper or aluminum, and the second current collector may be made of the same material as that of the first current collector.

According to another exemplary embodiment of the present invention, there is provided an energy storage apparatus including: a negative electrode; a positive electrode facing the negative electrode, having a separator therebetween;and an electrolyte solution providing a carrier ion of a charging and discharging reaction mechanism between the negative electrode and the positive electrode, wherein at least one of the negative electrode and the positive electrode includes: a first current collector facing the separator and having a flat plate structure; second current collectors stacked on the first current collector toward the separator and having a mesh structure; and active material layers formed on the first and second current collectors.

The second current collectors may be stacked in plural so as to face the first current collector, having the active material layer interposed therebetween.

The first current collector may have a first extension part extended in one direction, the second current collector may have second extension part extended in one direction so as to face the first extension part, and the electrode structure may further include a connection part connecting the first and second extension parts to each other.

### BRIEF DESCRIPTION OF THE DRAWINGS

FIG. 1 is an exploded perspective view of an electrode structure according to an exemplary embodiment of the present invention;

FIG. 2 is an assembled cross-sectional view of the electrode structure according to the exemplary embodiment of the present invention; and

FIG. 3 is a view showing an energy storage apparatus according to an exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, an electrode structure, a method of manufacturing the same, and an energy storage apparatus including the same will be described in detail with reference to the accompanying drawings.

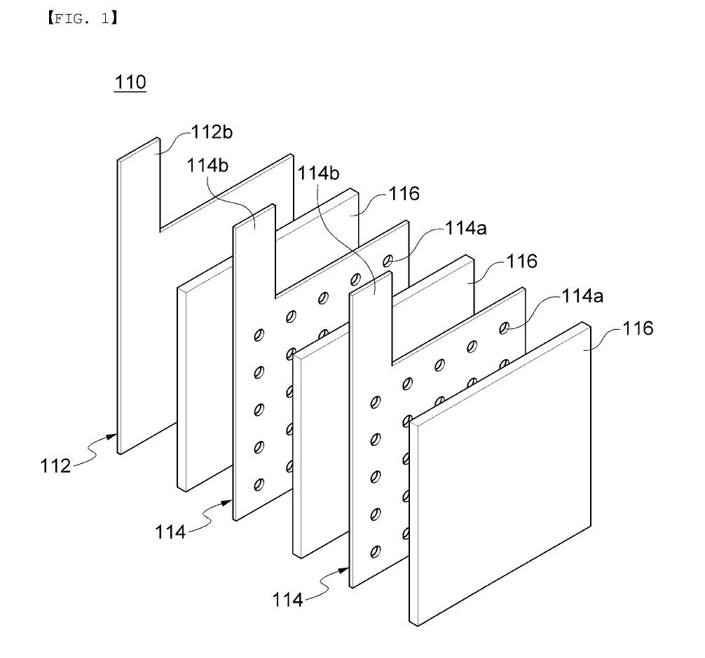

FIG. 1 is an exploded perspective view of an electrode structure according to an exemplary embodiment of the present invention, and FIG. is an assembled cross-sectional view of the electrode structure according to the exemplary embodiment of the present invention.

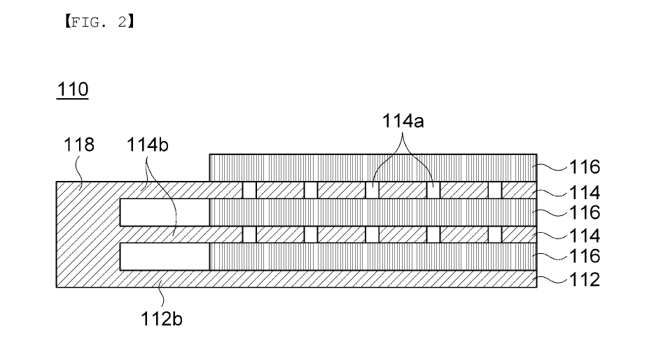

Referring to FIGS. 1 and 2, the electrode structure 110 according to the exemplary embodiment of the present invention may be an electrode for a predetermined energy storage apparatus. As an example, the electrode structure 110 may be any one of a positive electrode and a negative electrode of an energy storage apparatus, so-called an ultra-capacitor or a super-capacitor. As another example, the electrode structure 110 may be any one of a positive electrode and a negative electrode of a lithium ion capacitor (LIC).

The electrode structure 110 may include a first current collector 112, a second current collector 114, an active material layer 116, and a connection part 118.

The first current collector 112 may be a metal foil having a flat plate shape. For example, as the first current collector 112, a metal foil made of any one of copper and aluminum may be used.

The second current collector 114 may be disposed so as to be spaced apart from the first current collector 112 by a predetermined interval while facing the first current collector 112. The second current collector 114 may be a metal foil made of the same material as that of the first current collector 112 and have an approximately similar size and shape to those of the first current collector 112. However, the second current collector 114 may have a mesh structure unlike the first current collector 112. That is, a plurality of through holes 114a disposed by a predetermined interval in the second current collector 114 across the board may be formed in the second current collector 114. The through holes 114a may provide moving paths of carrier ions for charging and discharging reactions at the time of charging and discharging operations of the energy storage apparatus.

Meanwhile, at least one of the second current collectors 114 may be stacked on the first current collector 112. For example, a plurality of second current collectors 114 may be included, and the plurality of second current collectors 114 may be sequentially stacked on the first current collector 112, having the active material layer 116 interposed therebetween. Each of the second current collectors 114 stacked as described above may have the same shape and material.

The active material layer 116 may be formed on surfaces of the first and second current collectors 112 and 114. In addition, the active material layer 116 may be filled in the through hole 114a. The active material layer 116 may be a film formed by preparing a predetermined active material composition in a slurry form and then apply the prepared slurry onto the surfaces of the first and second current collectors 112 and 114. The active material layer 116 may be configured of an active material, a conductive material, a binder, and the like.

As the active material, a carbon material may be used. For example, the active material may include at least one of activated carbon, graphite, carbon aerogel, polyacrylonitrile (PAN), carbon nano fiber (CNF), activating carbon nano fiber (ACNF), and vapor grown carbon fiber (VGCF). The conductive material is to impart conductivity to the active material composition. As the conductive material, a carbon based material having high electric conductivity and various kinds of metal nano particles may be used. For example, as the conductive material, at least one of carbon black, Ketjen black, carbon nano tube, and graphene may be used. In addition, the binder is provided in order to improve physical properties of the slurry composition, and PTFE, PVP, SBR, Acryl, polyvinylidene fluoride (PVDF) or cellulose based materials may be used as the binder.

The connection part 118 may electrically connect the first and second current collectors 112 and 114 to each other. For example, each of the first and second current collectors 112 and 114 may be provided with first and second extension parts 112b and 114b in order to be electrically connected to an external electrode terminal (not shown). The first and second extension parts 112b and 114b are disposed to face each other, and the active material layer 116 may not be interposed therebetween. The connection part 118 may be a single metal pattern connecting the first and second extension parts 112b and 114b to each other. In this case, a material of the connection part 118 may be the same as that of the first and second current collectors 112 and 114.

The electrode structure 110 for an energy storage apparatus having the above-mentioned structure may include a first current collector 112 having a flat plate shape, a plurality of second current collectors 114 stacked on the first current collector 112 and having a mesh structure, active material layers 116 formed between the first and second current collectors 112 and 114, and a connection part 118 electrically connecting the first and second current collectors 112 and 114 to each other. Since the electrode structure 110 as described above has a structure in which the plurality of current collectors 112 and 114 electrically connected to each other are provided therein and the active material layers 116 are formed therebetween, the electric resistance of the electrode itself may be reduced, and distances from the active material layer 116 to each of the first and second current collectors 112 and 114 may be minimized, such that moving efficiency of the carrier ions in the electrolyte solution may be increased. Particularly, the first current collector 112 has the flat plate structure, but the second current collectors 114 stacked on the first current collector 112 have the mesh structure, such that the electrolyte solution may move through the through holes 114a up to the first and second current collectors 112 and 114 that are disposed far away from the electrolyte solution. Therefore, in the electrode structure according to the exemplary embodiment of the present invention, the plurality of current collectors are stacked, such that the resistance of the electrode may be reduced, and the remaining current collectors except for the current collector disposed farthest away based on a separator have a mesh structure, such that the electrolyte solution may effectively move up to the active material layer formed at the outermost current collector, thereby making it possible to improve output and capacitance characteristics, and cycle life characteristics of the energy storage apparatus.

Hereinafter, an energy storage apparatus according to an exemplary embodiment of the present invention will be described in detail. Herein, a description of contents overlapping with the electrode structure 110 described with reference to FIGS. 1 and 2 may be omitted or simplified.

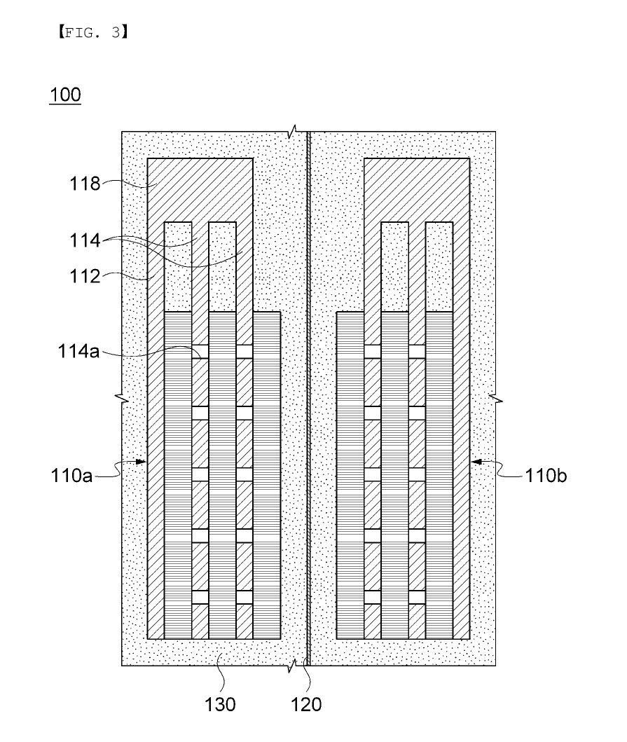

FIG. 3 is a view showing an energy storage apparatus according to an exemplary embodiment of the present invention. Referring to FIGS. 1 to 3, the energy storage apparatus 100 according to the embodiment of the present invention may include electrode structures 110a and 110b, a separator 120, and an electrolyte solution 130.

Each of the electrode structures 110a and 110b may have approximately equal or similar structure to that of the electrode structure 110 described above with reference to FIGS. 1 and 2. The electrode structures 110a and 110b may be disposed to face each other, having the separator 120 therebetween. Among the electrode structures 110a and 110b, the electrode structure 110a disposed at one side based on the separator 120 may be used as a negative electrode of the energy storage apparatus 200, and the electrode structure 110b disposed at the other side may be used as a positive electrode of the energy storage apparatus 200.

Each of the first electrode structure 110a (hereinafter, referred to as “the negative electrode”) and the second electrode structure 110b (hereinafter, referred to as “the positive electrode”) may have a first current collector 112 disposed at the outermost portion based on the separator 120, second current collectors 114 stacked on the first current collector 112 toward the separator 120 and having a mesh structure, and active material layers 116 formed on surfaces of the first and second current collectors 112 and 114. The first and second current collectors 112 and 114 may have first and second extension parts 112b and 114b extended upwardly and electrically connected by the connection part 118.

The separator 120 may be disposed between the negative electrode 110a and the positive electrode 110b to electrically separate the negative electrode 110a and the positive electrode 110b from each other. As the separator 120, at least one of a non-woven fabric, poly tetra fluoroethylene (PTFE), a porous film, Kraft paper, a cellulose based separator, a rayon fiber, and various other kinds of sheets may be used.

The electrolyte solution 130 may be a composition prepared by dissolving an electrolyte in a predetermined solvent. For example, the electrolyte may be a lithium based electrolyte salt (hereinafter, referred to as “a lithium salt”). The lithium salt may be a salt including lithium ion (Li+) as a carrier ion between the negative electrode 110a and the positive electrode 110b at the time of charging and discharging operation of the energy storage apparatus 100. The lithium salt may include at least one of LiPF6, LiBF4, LiSbF6, LiAsF5, LiClO4, LiCF3SO3, LiN(SO2CF3)2, LiN(SO2C2F5)2, LiC(SO2CF3)3, LiPF4(CF3)2, LiPF3(C2F5)3, LiPF3(CF3)3, LiPF3(iso-C3F7)3, LiPF5(iso-C3F7), (CF2)2(SO2)2NLi, and(CF2)3(SO2)2NLi.

As another example, the electrolyte may be a non-lithium based electrolyte salt. The non-lithium salt may be a salt including non-lithium ion as the carrier ion between the negative electrode 110a and the positive electrode 110b at the time of charging and discharging operation of the energy storage apparatus 100. For example, the non-lithium based electrolyte salt may include ammonium based positive ions (NR4⁺). More specifically, the non-lithium based electrolyte salt (hereinafter, referred to as “the ammonium salt”) may include at least one of tetraethyl ammonium tetrafluoroborate (TEABF4), triethylmethyl ammonium tetrafluoroborate (TEMABF4), diethyldimethyl ammonium tetrafluoroborate (DEDMABF4), diethyl-methyl-methoxyethyl ammonium tetrafluoroborate (DEMEBF4). Alternately, the non-lithium based electrolyte salt may include spirobipyrrolidinium tetrafluoroborate (SBPBF4), spiropiperidinepyrrolidinium tetrafluoroborate (SPPBF4), or the like.

In the energy storage apparatus 100, any one of the lithium salt and the ammonium salt may be used alone, or the lithium salt and the ammonium salt may be mixed and used.

The solvent may include at least one of cyclic carbonates and linear carbonates. For example, as the cyclic carbonate, at least one of ethylene carbonate (EC), propylene carbonate (PC), butylene carbonate (BC), and vinyl ethylene carbonate (VEC) may be used. As the linear carbonate, at least one of dimethyl carbonate (DMC), ethyl methyl carbonate (EMC), diethyl carbonate (DEC), methylpropyl carbonate (MPC), dipropyl carbonate (DPC), methyl butyl carbonate (MBC), and dibutyl carbonate (DBC) may be used. In addition, various kinds of ether, ester, and amide based solvents such as acetonitrile, propionitrile, gamma butyrolactone, sulfolane, ethyl acetate, methyl acetate, methyl propionate, or the like, may be used.

The energy storage apparatus 100 having the above-mentioned structure may be used as an electric double layer capacitor (EDLC) driven by using activated carbons and using an electric double layer charging as a charging and discharging reaction mechanism. In addition, the energy storage apparatus 100 may be used as a lithium ion capacitor (LIC) using a lithium ion (Li+) as a carrier ion of an electro-chemical reaction mechanism.

Meanwhile, as described above with reference to FIGS. 1 and 2, the electrode structure 110 according to the exemplary embodiment of the present invention may reduce the electrical resistance by including the plurality of current collectors 112 and 114 and improve the moving efficiency of the carrier ion by minimizing the distance from the active material layer 116 to each of the first and second current collectors 112 and 114. In the energy storage apparatus 100 including the-above mentioned electrode structures 110 as the negative electrode 110a and the positive electrode 110b, internal resistance may be reduced, and a phenomenon that the moving efficiency of the carrier ion is decreased toward the current collector when the thickness of the active material layer 120 is increased may be prevented, while increasing the amount of the active material layer 120. Therefore, in the energy storage apparatus according to the exemplary embodiment of the present invention, a plurality of multi-layer current collectors are provided, such that the electrode resistance generated when the thickness of the active material layer is thick in order to increase capacitance may be reduced, and the remaining current collectors except for the current collector disposed farthest away based on a separator have a mesh structure, such that the electrolyte solution may effectively move up to the active material layer formed at the outermost current collector, thereby making it possible to simultaneously improve output and capacitance characteristics.

As set forth above, in the electrode structure according to the exemplary embodiment of the present invention, the plurality of current collectors are stacked, such that the resistance of the electrode may be reduced, and other current collectors except for the current collector disposed farthest away based on a separator have a mesh structure, such that the electrolyte solution may effectively move up to the active material layer formed at the outermost current collector, thereby making it possible to improve output and capacitance characteristics, and cycle life characteristics of the energy storage apparatus.

With the energy storage apparatus according to the exemplary embodiment of the present invention, a plurality of multi-layer current collectors are provided, such that the electrode resistance generated when the thickness of the active material layer is thick in order to increase capacitance may be reduced, and the remaining current collectors except for the current collector disposed farthest away based on a separator have a mesh structure, such that the electrolyte solution may effectively move up to the active material layer formed at the outermost current collector, thereby making it possible to simultaneously improve output and capacitance characteristics.

The present invention has been described in connection with what is presently considered to be practical exemplary embodiments. Although the exemplary embodiments of the present invention have been described, the present invention may be also used in various other combinations, modifications, and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. An electrode structure comprising:
a first current collector having a flat plate structure;
second current collectors stacked on the first current collector and having a mesh structure; and
active material layers formed on the first and second current collectors.

2. The electrode structure according to claim 1, wherein the second current collectors are stacked in plural so as to face the first current collector, having the active material layer interposed therebetween.

3. The electrode structure according to claim 1, wherein the second current collector has a plurality of through holes, and the through holes are filled with the active material layer.

4. The electrode structure according to claim 1, wherein it is at least one of a negative electrode and a positive electrode that are disposed, having a separator therebetween, and
the first current collector is disposed at the outermost portion from the separator as compared with the second current collector.

5. The electrode structure according to claim 1, wherein the first current collector has a first extension part extended in one direction,
the second current collector has a second extension part facing the first extension part, and
the electrode structure further comprising a connection part connecting the first and second extension parts to each other.

6. The electrode structure according to claim 1, wherein the first current collector is a metal foil made of copper or aluminum, and
the second current collector is made of the same material as that of the first current collector.

7. An energy storage apparatus comprising:
a negative electrode;
a positive electrode facing the negative electrode, having a separator therebetween; and
an electrolyte solution providing a carrier ion of a charging and discharging reaction mechanism between the negative electrode and the positive electrode,
wherein at least one of the negative electrode and the positive electrode includes:
a first current collector facing the separator and having a flat plate structure;
second current collectors stacked on the first current collector toward the separator and having a mesh structure; and
active material layers formed on the first and second current collectors.

8. The energy storage apparatus according to claim 7, wherein the second current collectors are stacked in plural so as to face the first current collector, having the active material layer interposed therebetween.

9. The energy storage apparatus according to claim 7, wherein the first current collector has a first extension part extended in one direction,
the second current collector has a second extension part extended in one direction so as to face the first extension part, and
the electrode structure further comprising a connection part connecting the first and second extension parts to each other.
